(19) United States
(12) Patent Application Publication
(10) Pub. No.: US 2006/0140399 A1
(43) Pub. Date: Jun. 29, 2006

(54) Pre-calculation mechanism for signature decryption

(76) Inventor: David Walter Young, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/023,859

(22) Filed: Dec. 28, 2004

(51) Int. Cl. H04L 9/30

(52) U.S. Cl. 380/30

(57) ABSTRACT

According to one embodiment, a method is disclosed. The method includes generating an RSA signature of a document at a first device, performing decryption pre-calculations on the RSA signature at the first device to generate a transformed encrypted signature, transmitting the transformed encrypted signature data to a second device for final decryption.

### FIELD OF THE INVENTION

The present invention relates to computer systems; more particularly, the present invention relates to authenticating data received at a computer system.

### BACKGROUND

The increasing number of financial and personal transactions being performed on local or remote microcomputers has given impetus for the establishment of “trusted” or “secured” microprocessor environments. The problem these environments attempt to solve is that of loss of privacy, or data being corrupted or abused.

Often programming data for computer system components, such as Central Processing Units (CPUs), embedded processors or chipsets, are received to update software or firmware within the system. However, if the programming data is received from un-trusted or unsecured sources it may include malicious code that could potentially be used to modify data transmitted to/from the computer system.

### BRIEF DESCRIPTION OF THE DRAWINGS

The invention is illustrated by way of example and not limitation in the figures of the accompanying drawings, in which like references indicate similar elements, and in which:

FIG. 1 illustrates one embodiment of a network;

FIG. 2 is a block diagram of one embodiment of a computer system;

FIG. 3 is a flow diagram for one embodiment for transmitting secure data to a computer system; and

FIG. 4 illustrates one embodiment for performing a pre-calculation process.

### DETAILED DESCRIPTION

A method for transmitting secure data to between a source device and a receiving device is described. The method includes the source device generating an RSA signature for a document and performing calculations to begin the decrypting the RSA signature SU prior to transmission of the document to the receiving device.

In one embodiment, the pre-calculations involves calculating an Inverse Low-Order Prime Modulus Digit (N0_prime), and transforming the signature data into a Montgomery format. Additionally, the pre-calculation process may also include performing no subtract header adjustments to eliminate the need for “Compare and Subtract” routines at the receiving device.

After the pre-calculations are performed, the document, the Montgomery formatted RSA Signature and the N0_prime value are transmitted from the source device to the receiving device. At the receiving device the final steps of the decryption process occur, and the Montgomery formatted result is then converted back to a scalar format

Subsequently, a hash of the programming data is performed at ACM 109 using the public encryption key, and a comparison of the hash of the document to the hash from the converted Montgomery value occurs to determine if the document is authentic.

In the following detailed description of the present invention, numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The instructions of the programming language(s) may be executed by one or more processing devices (e.g., processors, controllers, control processing units (CPUs),

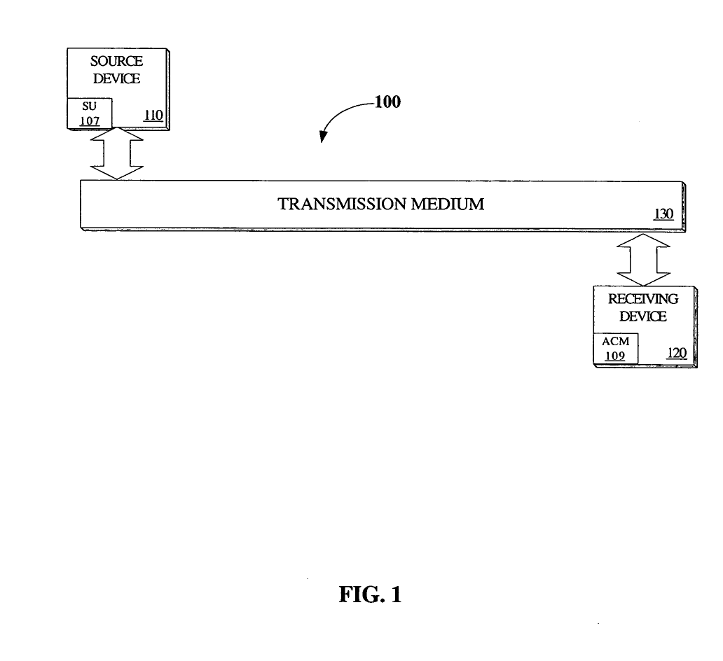

FIG. 1 illustrates one embodiment of a network 100. Network 100 includes a computer system 110 and a computer system 120 coupled via a transmission medium 130. In one embodiment, computer system 110 operates as a source device that sends an object to computer system 120, operating as a receiving device. The object may be, for example, a data file, programming data, an executable, or other digital objects. The object is sent via data transmission medium 130. The data transmission medium 130 may be one of many mediums such as an internal network connection, an Internet connection, or other connections. The transmission medium 130 may be connected to a plurality of untrusted routers (not shown) and switches (not shown).

According to one embodiment, programming data may be transmitted from the source device to the receiving device in order to update software or firmware within device 120. In a further embodiment, the programming data is transmitted with encrypted signature data to ensure that the patch is from a trusted source. As a result, source device 110 includes a signing unit (SU) 107 to generate authenticating signatures, and receiving device includes an authenticated code module (ACM) 109 to authenticate the received signatures.

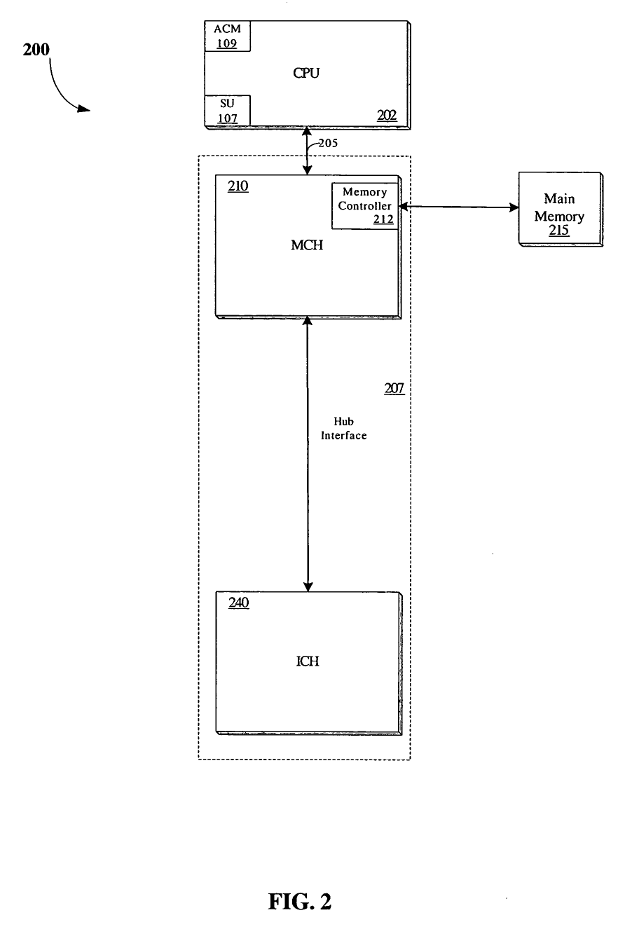

FIG. 2 is a block diagram of one embodiment of a computer system 200. Computer system 200 may be implemented as computer system 110 or computer system 120 (both shown in FIG. 1). Computer system 200 includes a central processing unit (CPU) 202 coupled to bus 205. A chipset 207 is also coupled to bus 105. Chipset 207 includes a memory control hub (MCH) 210. MCH 210 may include a memory controller 212 that is coupled to a main system memory 215. Main system memory 215 stores data and sequences of instructions that are executed by CPU 202 or any other device included in system 200.

In one embodiment, main system memory 215 includes dynamic random access memory (DRAM); however, main system memory 215 may be implemented using other memory types. Additional devices may also be coupled to bus 205, such as multiple CPUs and/or multiple system memories. MCH 110 is coupled to an input/output control hub (ICH) 240 via a hub interface. ICH 240 provides an interface to input/output (I/O) devices within computer system 200.

As disclosed above, programming data may be received at computer system 200 to update software or firmware within computer system 200. In addition, computer system 200 may be implemented to transmit the data. According to one embodiment, ICH 240 patch programming data may be received at a computer system 200. For instance, computer system 200 may be a receiving device that receives the patch from a source device, or may be the source device itself.

As previously mentioned, the patch programming data is transmitted along with encryption data to ensure that the patch data is from a trusted source. As a result, CPU 202 includes SU 107 for embodiments where computer system 200 is a source device, and includes ACM 109 for embodiments where computer system 200 is a receiving device.

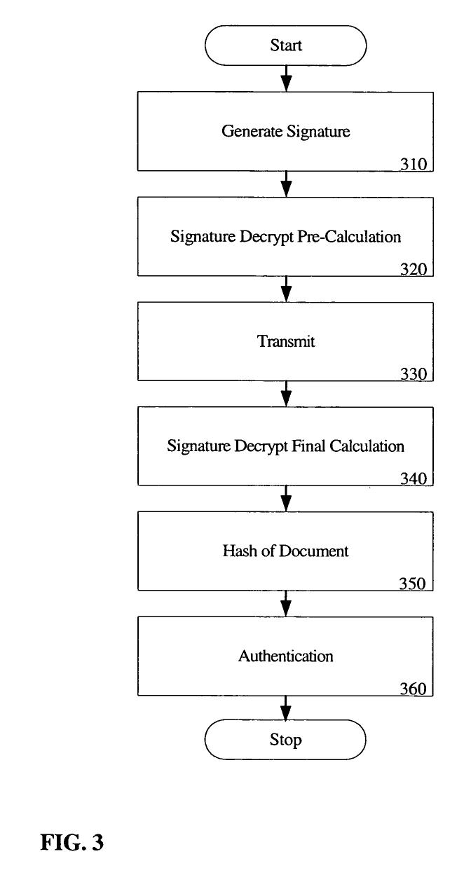

FIG. 3 is a flow diagram illustrating a process for one embodiment for transmitting secure data to between a source device and a receiving device. At processing block 310, SU 107 at a source device generates an authentication signature. According to one embodiment, SU 107 generates RSA signatures. As a result, SU 107 uses a hash algorithm to generate a cryptographic hash of a document such as the programming data.

Once the hash has been created it is added to the low order (e.g., lower 160 bits) of a bit field (e.g., 248 bits), with the remainder of the bit field having pre-defined “padding” values. Subsequently, SU 107 uses a private key to encrypt the padded hash value into an encrypted result. Thus, the RSA signature has been completed.

At processing block 320, SU 107 begins to decrypt the RSA signature be performing pre-calculations. Generally, the RSA signature is decrypted as part of the signature validation process by being raised to some exponential power over a modular field, where a modulus of a public key defines the field. Such, decryption is typically performed at an ACM. However, having the ACM perform the full decryption process requires a relatively larger scratch space in cache, which will affect the performance of the computer system.

The size of the ACM is important since the ACM is to fit within the smallest lowest level cache size in any CPU that utilizes an ACM. The Montgomery format transformation for the decrypt can be performed at the signing unit, without any loss in the security of the signature in order to eliminate the need for the Montgomery transforming code or the N0_prime calculation in the ACM.

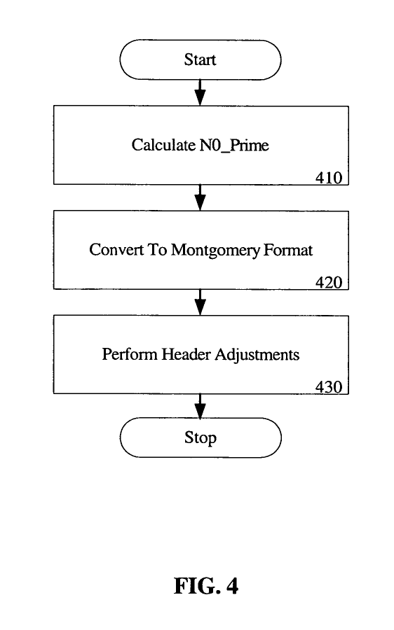

Therefore, decryption pre-calculations are performed at SU prior to transmission of the data to the receiving device. According to one embodiment, the pre-calculations transform the signature data into a Montgomery format. FIG. 4 illustrates one embodiment for performing the pre-calculation process. At processing block 410, an Inverse Low-Order Prime Modulus Digit (N0_prime) is calculated. The N0_prime computation is an algorithm that calculates the Montgomery value of the lowest digit of the modulus times a so-called “minus 1”, or inverse value in a modular field of positive integers. This value is implemented during the “divide” or “reduction” phase of some kinds of Montgomery based calculations.

At processing block 420, the RSA Signature is converted from a scalar format into the Montgomery format. As discussed above, this would require a significant amount of ACM code to implement since it requires a big number division algorithm. In one embodiment, the Montgomery formatted RSA Signature is the same size as the scalar-format RSA Signature and replaces the scalar-format RSA Signature in the Chipset Patch header (or another payload's header).

At processing block 430, no subtract header adjustments are performed by SU 107 to eliminate the need for “Compare and Subtract” routines at the end of each Montgomery multiply. Note that this is optional component of the process that results in additional code size reduction in the ACM. With the addition of this phase, very little software is required to implement the Montgomery exponentiation.

To perform the adjustments, SU 107 chooses a public key exponent of 3 when generating the RSA Key Pair for signing. Note that a public key exponent equal to 3 is not recommended for data encryption but that it is fine for use with RSA Signature schemes. In one embodiment, SU 107 implements an iterative process to modify the signed data, or other, header by methodically modifying (e.g. add 1) to an adjustment field that resides in the range of data to be signed; measuring the header and module with the signature hash; merging RSA padding with the signature hash and encrypt with the private RSA key providing the encrypted signature; converting the encrypted signature to the Montgomery format; and raising the Montgomery-formatted base to 3^{rd} power. A test is then made to see whether subtraction was necessary. The number of iterations that are implemented for this process will vary with each modulus, with 10-50 iterations generally occurring to obtain a case where no subtraction is necessary.

Referring back to FIG. 3, the programming data, the Montgomery formatted RSA Signature and the N0_prime value is transmitted from the source device to the receiving device, processing block 330. At processing block 340, a final reduction of the decryption process occurs at ACM 109 within the receiving device.

This process saves scratch-space through the use of in-place Montgomery multiplication routines and takes advantage of the fact that the lower halves of the product values in Montgomery multiplies are discarded (e.g., propagate the carried digits from low to high order during multiplication). Thus, the size of the Montgomery product buffer is not required to exceed the size of the reduced Montgomery product by more than 2 digits, where the digits are 32 or 64 bits.

This process includes multiplying the Montgomery value in order to raise the values to the 3^{rd} power. Subsequently, the value is reduced to convert the result from a Montgomery to a scalar format. The conversion is performed by further multiplying by a prime number (e.g., 1). The result of this multiplication is the decrypted signature with the padding and signature hash data.

At processing block 350, a hash of the programming data is performed at ACM 109 using the public encryption key. At processing block 360, ACM 109 compares the hash of the programming data to the hash from the converted Montgomery value to determine if the programming data is authentic.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method comprising:
generating an RSA signature of a document at a first device;
performing decryption pre-calculations at the first device to generate a transformed encrypted signature; and
transmitting the transformed encrypted signature to a second device for final decryption.

2. The method of claim 1 wherein performing decryption pre-calculations comprises:
calculating an Inverse Prime Low-Order Modulus Digit (N0_prime); and
converting the RSA signature from a scalar format to a Montgomery formatted RSA signature.

3. The method of claim 2 wherein performing decryption pre-calculations comprises performing no subtract header adjustments to eliminate the need for compare and subtract routines during the final decryption.

4. The method of claim 2 wherein transmitting the transformed encrypted signature comprises transmitting the Montgomery formatted RSA Signature and the N0_prime.

5. A method comprising:
receiving pre-calculated encrypted signature data at a first device from a second device; and
performing final decryption of the pre-calculated decrypted signature data.

6. The method of claim 5 wherein receiving the pre-calculated encrypted data comprises receiving a Montgomery formatted RSA Signature and an Inverse Prime Low-Order Modulus Digit (N0_prime) which is to be used to verify an accompanying document.

7. The method of claim 6 wherein performing the final decryption reduction of the pre-calculated encrypted signature comprises converting the Montgomery formatted RSA Signature to a scalar format.

8. The method of claim 1 wherein performing the final decryption of the pre-calculated decrypted document further comprises:
multiplying the Montgomery formatted RSA Signature to the 3^{rd} power; and
multiplying by a prime number.

9. The method of claim 5 further comprising performing a hash operation on the document.

10. The method of claim 9 further comprising determining the authenticity of the document by comparing the hash of the document to the decrypted.

11. A system comprising:
a main memory device;
an integrated circuit (IC); and
a central processing unit (CPU) having an authenticated code module (ACM) to receive pre-calculated encrypted signature data, and to perform final decryption of the pre-calculated encrypted signature data.

12. The system of claim 11 wherein the pre-calculated encrypted signature data is received as a Montgomery formatted RSA Signature.

13. The system of claim 12 wherein the ACM also receives programming data and an Inverse Prime Low-Order Modulus Digit (N0_prime).

14. The system of claim 5 wherein the ACM performs a hash operation on the programming data.

15. An article of manufacture including one or more computer readable media that embody a program of instructions, wherein the program of instructions, when executed by a processing unit, causes the processing unit to:
generate an RSA signature of a document at a first device;
perform decryption pre-calculations at the first device to generate a transformed encrypted signature; and
transmit the transformed encrypted signature to a second device for final decryption.

16. The article of manufacture of claim 15 wherein the program of instructions, when executed by a processing unit, further causes the processing unit to:
calculate an Inverse Prime Low-Order Modulus Digit (N0_prime); and
convert the RSA signature from a scalar format to a Montgomery formatted RSA signature.

17. The article of manufacture of claim 16 wherein the program of instructions, when executed by a processing unit, further causes the processing unit to perform no subtract header adjustments to eliminate the need for compare and subtract routines during the final decryption.

18. The article of manufacture of claim 16 wherein the program of instructions, when executed by a processing unit, further causes the processing unit to transmit the Montgomery formatted RSA Signature and the N0_prime.

19. A central processing unit (CPU) comprising:
an authenticated code module (ACM) to receive pre-calculated encrypted signature data, and to perform final decryption of the pre-calculated encrypted signature data.

20. The CPU of claim 19 wherein the pre-calculated encrypted signature data is received as a Montgomery formatted RSA Signature.

21. The CPU of claim 20 wherein the ACM also receives a Montgomery formatted RSA Signature and an Inverse Prime Low-Order Modulus Digit (N0_prime) which is to be used to verify an accompanying document.

22. The CPU of claim 19 wherein the ACM performs a hash operation on the programming data.
